(19) United States
(12) Patent Application Publication
(10) Pub. No.: US 2011/0004848 A1
(43) Pub. Date: Jan. 6, 2011

(54) Interface for Entering Option Orders that Simultaneously Accommodates Simple Options, Spreads, and Complex Spreads

(75) Inventors: Peter G. Scheffler, Barrington Hills, IL (US); Peter Krause, Chicago, IL (US)

Correspondence Address: MILLER, MATTHIAS & HULL, ONE NORTH FRANKLIN STREET, SUITE 2350, CHICAGO, IL, 60606, US

(73) Assignee: X-Change Financial Access, LLC, Chicago, IL (US)

(21) Appl. No.: 12/829,832

(22) Filed: Jul. 2, 2010

Related U.S. Application Data
(60) Provisional application No. 61/223,246, filed on Jul. 6, 2009.

(51) Int. Cl. G06F 3/048

(52) U.S. Cl. 715/810

(57) ABSTRACT

A user interface for entering option orders is disclosed. The user interface may include a display page having, a plurality of display objects and a display line. The plurality of display objects may represent individual options, individual spreads, and commands. The display line may depict the plurality of display objects stringed together in the order selected by a user. If at least two of the plurality of display objects selected are individual spreads, then a complex spread may be depicted on the display line. Upon the selection of a command, an order may be build consisting of the plurality of display objects depicted on the display line. The order may be built on a second display page. The second display page may color code each individual option and individual spread selected and may provide adjustable fields and buttons for data customization of each individual option and individual spread.

### FIELD OF THE DISCLOSURE

The present disclosure generally relates to an order entry system and, in particular, relates to a user interface for entering option orders that simultaneously accommodates individual options, spreads, and complex spreads.

### BACKGROUND OF THE DISCLOSURE

Professional Securities Traders use options (calls and puts) to generate streams of returns based on changes in the financial instrument underlying those options and changes in the option prices themselves. In early days of option trading, most trades were simple options, calls and puts, and bets on the direction of price movement in the underlying security. Shortly afterwards, after options were listed on the Chicago Board Options Exchange, it became more common for professional traders to think of options in terms of spreads. A spread is a combination of options with a specific anticipated revenue distribution based on the probability of different types of changes in both the underlying and the prices of the options themselves. Individual options, calls and puts, are bets on the direction of an underlying financial instrument, and spreads allow traders to either place or back bets on more specific types of price movement. For example, a ratio call spread, buying one call at a close strike price and selling two calls at a more distant strike price, is a bet that the financial instrument will go up, but not too much. The various spreads are discussed in more detail in literatures on options such as, for example, MacMillan 1987.

Most electronic order entry systems have a way to enter spreads and individual options, and a few of them have a way to enter complex spreads. A complex spread is spread whose individual “legs” consist of other spreads. Option order entry interfaces fall into several categories. Most option order entry interfaces have a simple screen designed for entering individual option orders and a slightly more complicated screen for entering spreads. Some of them have unified screen with a drop-down menu to select the spread type and dynamically change the screen to reflect the defaults for that spread type. These screens might have a way to add a spread or add a leg to an existing spread, using a button or a drop-down menu. All order entry screens that have been introduced to the market thus far make it cumbersome to add spreads that are comprised of individual spreads, i.e. complex spreads. As a result, few brokerage firms electronically support complex spreads. In the past, complex spreads, even though they are more versatile and often have less slippage than simple spreads, are not as common as simple spreads, thus insofar as they were accommodated by electronic order entry systems, usually involved multi-step processes and different interfaces than the interface that is used to enter simple spreads or individual options. A need to improve the electronic entry of complex spreads still exists.

### SUMMARY OF THE DISCLOSURE

In accordance with one aspect of the disclosure, a user interface for entering option orders is disclosed. The user interface may include a display page having a plurality of display objects representing individual options, individual spreads, and commands, and a display line depicting the plurality of display objects stringed together in the order selected by a user.

In accordance with another aspect of the disclosure, a user interface for entering option orders is disclosed. The user interface may include a first display page and a second display page. The first display page may have a plurality of display objects representing individual options, individual spreads, and commands, and a display line depicting the plurality of display objects stringed together in the order selected by a user. Once the user builds an order consisting of the plurality of display objects being depicted on the display line by selecting at least one of the commands, the user may navigate to the second display page by means of a button. The second display page may color code each individual option and individual spread selected by the user and may place data of the selected individual options and individual spreads into adjustable fields and buttons for customization of data for each individual option and individual spread.

In accordance with yet another aspect of the disclosure, a method for entering an order consisting of individual options, individual spreads, and complex spreads using a single user interface is disclosed. The method may include providing a display page having a plurality of display objects and a display line, the plurality of display objects represent individual options, individual spreads, and commands; selecting a first display object from the plurality of display objects on the display page, the first display object is selected from a group consisting of individual options and individual spreads; depicting the first display object selected on the display line; selecting a second display object from the plurality of display objects on the display page, the second display object is selected from a group consisting of individual options, individual spreads, and commands; depicting the second display object selected adjacent to the first display object on the display line; and building an order consisting of the plurality of display objects being depicted on the display line upon the selection of a command.

Other advantages and features will be apparent from the following detailed description when read in conjunction with the attached drawings.

### BRIEF DESCRIPTION OF THE DRAWINGS

For a more complete understanding of the disclosed system and method, reference should be made to the embodiments illustrated in greater detail in the accompanying drawings, wherein:

FIG. 1 is an embodiment of a first display page of a user interface constructed in accordance with the teachings of the present disclosure;

FIG. 2 is an embodiment of a second display page of a user interface constructed in accordance with the teachings of the present disclosure;

FIG. 3 is another embodiment of a second display page of a user interface constructed in accordance with the teachings of the present disclosure; and

FIG. 4 is a flowchart depicting a sample sequence of steps which may be practiced in accordance with the method of the present disclosure.

It should be understood that the drawings are not necessarily to scale and that the disclosed embodiments are sometimes illustrated diagrammatically and in partial views. In certain instances, details which are not necessary for an understanding of the disclosed methods and systems or which render other details difficult to perceive may have been omitted. It should be understood, of course, that this disclosure is not limited to the particular embodiments illustrated herein.

### DETAILED DESCRIPTION OF THE DISCLOSURE

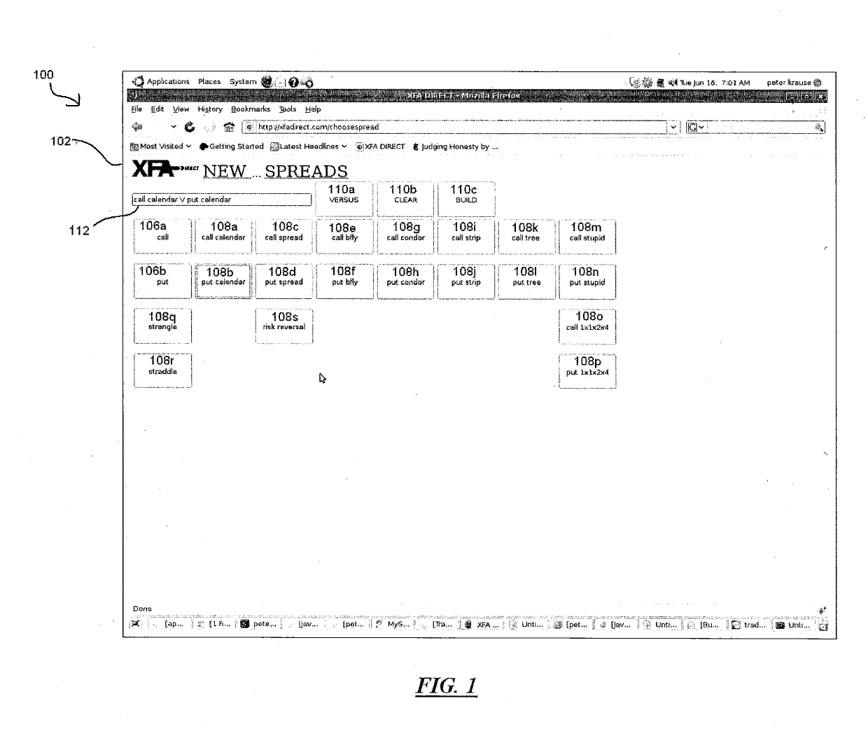

Referring to FIG. 1, a first display page 102 of a user interface 100 for entering option orders, which may be operated according to the principles of the present disclosure, is illustrated. The following description may be made with reference to a user interface for entering option orders, but it should be understood that the present disclosure may also be applied to entering orders for other financial instruments such as, but not limited to, stocks, bonds, commodity futures contracts, currency, and the like.

In FIG. 1, the first display page 102 of the user interface 100 may include a plurality of display objects 106-110 and a display line 112. The plurality of display objects 106-110 may represent individual options 106a-b, individual spreads 108a-s, and commands 110a-c. It should be understood that the plurality of individual options 106a-b and individual spreads 108a-s as depicted in FIG. 1 are exemplary embodiments and other embodiments of individual options and individual spreads know in the art may be feasible. The display line 112 may depict the plurality of display objects 106-110 being selected by a user. For instance, as the user selects each desired display object from the plurality of display objects 106-110, the display line 112 may depict each selected display object stringed together in the order selected by the user.

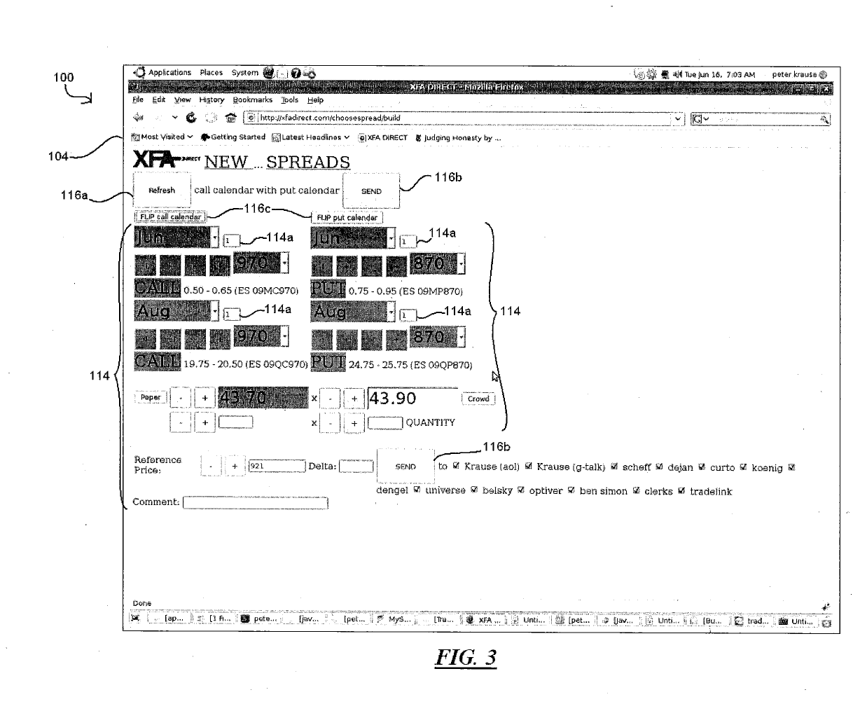

In one exemplary embodiment, as illustrated in FIG. 1, the user may first select the individual spread 108a, which may be depicted in the display line 112 as “call calendar”. The user may then select another display object, which may be an individual option 106a-b, another individual spread 108a-s, or a command 110a-c. In FIG. 1, the user selected the command—versus button 110a, which may be depicted on the display line 112 as “v”, adjacent to the first selected display object, the individual spread 108a—“call calendar”. The versus button 110a may represent the command to sell, or short, an option or spread. The user interface 100 may default to buy, or long, an option or spread when the versus button 110a is not selected following an individual option 106a-b or individual spread 108a-s. For instance, if the user had selected an individual option 106a-b or another individual spread 108a-s as the second display object, the user interface 100 would default to the command to buy, or a long position, by depicting a “with” instead of a “v” in the display line 112 between the first and second display objects selected, which is illustrated in FIG. 3.

Since the versus button 110a is selected as the second display object in FIG. 1, the user may then select a third display object which may be an individual option 106a-b or another individual spread 108a-s. The user interface 100 may not allow the user to select the versus button 110a twice, back-to-back, since this may violate logic rules for option orders. It should be understood that the user interface 100 has built-in capabilities to deter the user from entering invalid combinations of display objects that may violate logic rules for option orders, known to one skilled in the art. In FIG. 1, the user selected another individual spread 108b for the third display object, which is depicted in the display line 112 as “put calendar”. It should be understood that the user can continue to add display objects beyond the third selected display object and that the user is not limited to the number of display objects being added to the display line as long as no option order rules are violated, i.e. user should enter a valid option order. The user at any time may clear the display line 112 by selecting the clear button 110b. Once the clear button 110b is selected, all values in the display line 112 are cleared, the first display page 102 may be reset, and the user may restart entering their option order.

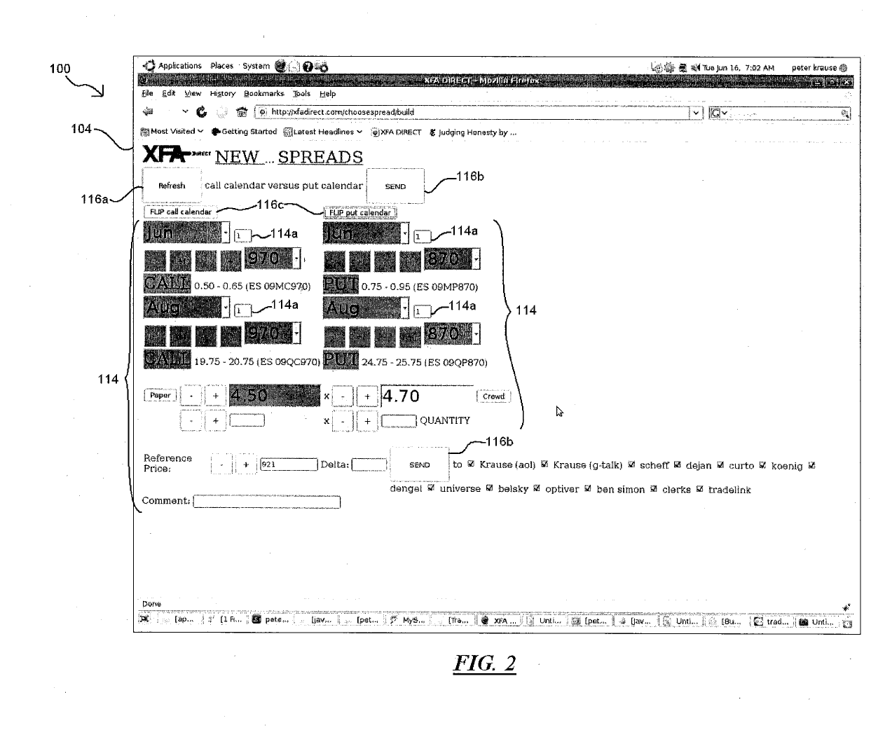

Once the user is ready to create the option order, the user may select the build button 110c. In FIG. 1, the user has easily created a complex order by selecting two individual spreads with the click of three buttons 108a, 110a, 108b. It should be understood that the user could have easily created the complex order with the click of two buttons 108a, 108b, wherein the user interface 100 would have defaulted to the buy option by inserting “with” between the two individual spreads 108a, 108b. Furthermore, it should be understood that the user could have easily created an individual option order by selecting a single individual option 106a-b or an individual spread order by selecting a single individual spread 108a-s using the same user interface 100, as was used for the complex order illustrated in FIG. 1. Once the user selects the build button 110c, a second display page may be created, as illustrated in FIG. 2.

In FIG. 2, the option order created by the user, in this example—the complex spread order, may be split-up into the individual spreads (options), wherein each individual spread (or option) selected by the user may be separated into columns and color coded for ease of identification by the user. In one exemplary embodiment, the individual spreads or options may be color coded based on whether the spread or option is being bought, a long position, or sold, a short position. The data in each individual spread (or option) may be placed in adjustable fields 114 for further customization by the user, before completing the order. Such adjustable fields 114, as depicted in FIGS. 2 and 3, are known in the art and a detailed description will be omitted herein. However, one adjustable field 114a provided by the user interface 100 which will be described herein is the ability to adjust the ratio quantity of the individual spread (or option) being ordered. The user interfaces disclosed in the market today do not allow the customization of the ratio quantity being order of the individual spreads in the complex order. The complex orders being order in the market today have predetermined combinations, wherein the quantity of each individual spread being ordered within the complex order is set to a predetermined value. The user interface 100 of the present disclosure may allow the user to adjust the ratio quantity of the individual spreads (or options) being ordered, even with a complex order.

The second display page 104 may also provide buttons 116a-c for further customization of the order and placing the order. The refresh button 116a may allow the user to reset the values of the individual spreads (options) in the adjustable fields 114 to the default values, which are the values prior to any manual adjustments made by the user. The send button 116b may be utilized by the user when the order is finalized and ready to be completed. The flip button 116c may allow the user to switch between the option to buy or sell. For instance, if the user made a mistake or changed their mind in buying the selected individual spread (or option) on the first display page 102, the user has the option to change to selling the selected individual spread (or option). For example, the complex order 108a, 110a, 108b created on the first display page 102 in FIG. 1, wherein the display line 112 read “call calendar versus put calendar”, build the order to sell the individual spread—put calendar 108b. If the user wants to buy the put calendar 108b now on the second display page 104, the user simply clicks on the flip button 116c, and the display line 112 may change to read “call calendar with put calendar”, as is illustrated in FIG. 3.

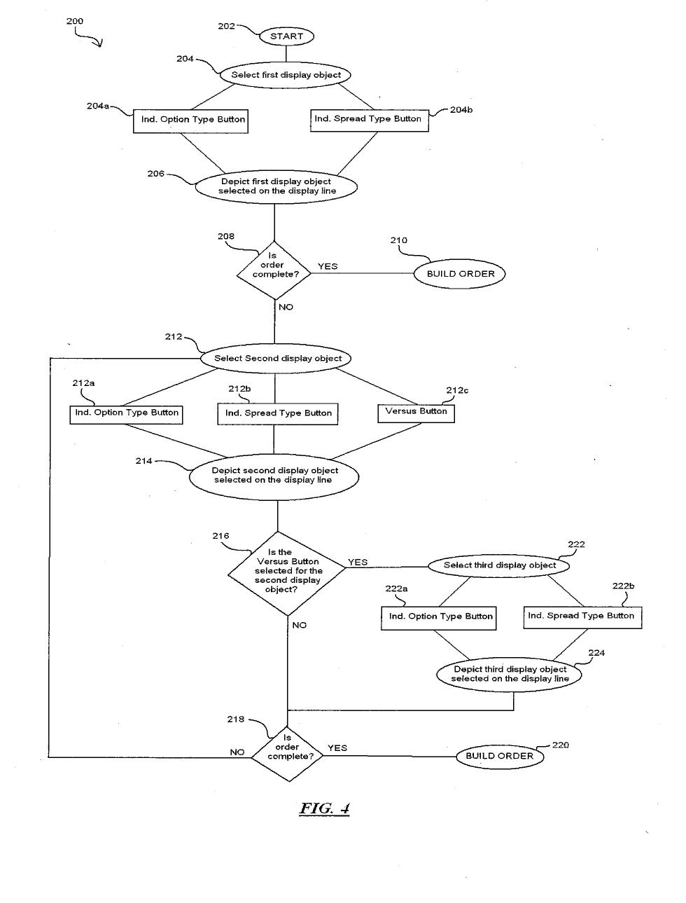

Referring now to FIG. 4, an exemplary flow-chart 200 depicting a method for entering an option order using the first display page 102 of the user interface 100 is disclosed. The first step 204 may be for the user to select a first display object. The user may either select an individual option 106a-b, in step 204a, or an individual spread 108a-s, in step 204b. Once the user has selected the first display object, in step 206, the display line 112 may depict the selected first display object. If the user desires an individual option order, wherein an individual option 106a-b is selected in step 204a, or an individual spread order, wherein an individual spread 108a-s is selected in step 204b, the user may decide to complete their order, in step 208, and build their order by selecting the build button 110c, in step 210.

However, if the user desires a complex order, the user may select a second display object, in step 212. The user may select an individual option 106a-b, in step 212a, an individual spread 108a-s, in step 212b, or the versus button 110a, in step 212c. The selected second display object may then be depicted on the display line 112, in step 214. If the user selects either an individual option 106a-b, in step 212a, or an individual spread 108a-s, in step 212b, then the user interface 100 may default to inserting the command “with” in between the first and second display objects being depicted on the display line 112. Since it is determined that the versus button 110a is not selected as the second display object, in step 216, the user may decide if the order is complete, in step 218. If the order is complete, the user may select the build button 110c, in step 220. If the order is not complete, the user may continue to select more display objects until the order becomes complete.

Referring back to step 216, if the user selected the versus button 110a as the second display object, the user may select a third display object, in step 222. The third display object may be an individual option 106a-b, in step 222a, or an individual spread 108a-s, in step 222b. The selected third display object may then be depicted on the display line 112, in step 224. At this point the user may determine if the order is complete, in step 218. If the order is not complete, the user may continue to select display objects until the order becomes complete. Once the order is complete, the user may build the order, in step 220, by selecting the build button 110c on the first display page 102. Upon the selection of the build button 110c, the second display page 104 may be created, depicting the order in detail.

It should be understood that the user interface 100 of the present disclosure may be accessed via a web browser, a downloadable application stored on a computer readable medium, or any other software means for utilizing a user interface 100 known to one skilled in the art. Furthermore, the user interface 100 of the present disclosure may be produced from a variety of software languages and algorithms known to one skilled in the art.

While only certain embodiments have been set forth, alternatives and modifications will be apparent from the above description to those skilled in the art. These and other alternatives are considered equivalents and within the spirit and scope of this disclosure and the appended claims.

What is claimed is:

1. A user interface for entering option orders, comprising:
a display page having,
a plurality of display objects representing individual options, individual spreads, and commands; and
a display line depicting the plurality of display objects stringed together in the order selected by a user.

2. The user interface of claim 1, wherein the commands are selected from a group consisting of a button that signals whether the selected individual option and spread is a short, a button that resets the display page and empties the display line, and a button that navigates to a second display page, with preset defaults of the most likely option, spread, and combination of spreads that the user will select.

3. The user interface of claim 1, wherein the individual options are selected from a group consisting of a put button and a call button representing a type of option.

4. The user interface of claim 1, wherein the individual spreads are selected from a group consisting of various put buttons and call buttons, each representing a type of spread.

5. The user interface of claim 1, whereupon the selection of at least two individual spreads creates a complex spread, which is depicted in the display line.

6. The user interface of claim 1, wherein at least one command allows the user to buy and sell each individual option and individual spread selected for an order.

7. The user interface of claim 1, wherein at least one command allows the user to build an order consisting of the plurality of display objects selected by the user and depicted on the display line.

8. The user interface of claim 7, whereupon the selection of the at least one command creates a second display page, the second display page color codes each individual option and individual spread selected for the order and provides adjustable fields and buttons for customization of data for each individual option and individual spread prior to completing the order.

9. A user interface for entering option orders, comprising:
a first display page having,
a plurality of display objects representing individual options, individual spreads, and commands; and
a display line depicting the plurality of display objects stringed together in the order selected by a user; and
a second display page color coding each individual option and individual spread selected by the user and placing data of the selected individual options and individual spreads into adjustable fields and buttons for customization of data for each individual option and individual spread.

10. The user interface of claim 9, wherein at least one adjustable field allows the user to adjust a ratio quantity of each individual option and individual spread being selected by the user for an order.

11. The user interface of claim 9, wherein at least one button on the second display page allows the user to reverse a position, which was selected by the user on the first display page, of each individual option and individual spread selected.

12. The user interface of claim 9, wherein the commands are selected from a group consisting of a button to signify a short position, a button to clear the first display page, and a button to navigate to the second display page.

13. The user interface of claim 9, wherein the individual options are selected from a group consisting of a put button and a call button representing a type of option.

14. The user interface of claim 9, wherein the individual spreads are selected from a group consisting of various put buttons and call buttons, each representing a type of spread.

15. The user interface of claim 9, whereupon the selection of at least two individual spreads creates a complex spread, which is depicted in the display line.

16. The user interface of claim 9, wherein at least one command allows the user to buy and sell each individual option and individual spread selected for an order.

17. The user interface of claim 9, wherein at least one command allows the user to build an order consisting of the plurality of display objects selected by the user and depicted on the display line.

18. A method for entering an order consisting of individual options, individual spreads, and complex spreads using a single user interface, comprising:
providing a display page having a plurality of display objects and a display line, the plurality of display objects represent individual options, individual spreads, and commands;
selecting a first display object from the plurality of display objects on the display page, the first display object is selected from a group consisting of individual options and individual spreads;
depicting the first display object selected on the display line;
selecting a second display object from the plurality of display objects on the display page, the second display object is selected from a group consisting of individual options, individual spreads, and commands;
depicting the second display object selected adjacent to the first display object on the display line; and
building an order consisting of the plurality of display objects being depicted on the display line upon the selection of a command.

19. The method of claim 18, wherein selecting an individual spread for the first display object and the second display object depicts a complex spread on the display line and builds a complex spread order.

20. The method of claim 18, wherein building an order is depicted on a second display page, the second display page color codes each individual option and individual spread selected for long and short positions, provides a button to change the position of each individual option and individual spread selected, and provides adjustable fields and buttons for data customization of each individual option and individual spread selected.
